(19) United States
(12) Patent Application Publication
(10) Pub. No.: US 2002/0135717 A1
(43) Pub. Date: Sep. 26, 2002

(54) Multi-slants reflector structure and manufacturing method thereof

(76) Inventor: Chung-Yuan Liu, Tai-Nan City (TW)

Correspondence Address: NAIPO (NORTH AMERICA INTERNATIONAL PATENT OFFICE), P.O. BOX 506, MERRIFIELD, VA, 22116, US

(21) Appl. No.: 10/063,086

(22) Filed: Mar. 18, 2002

(30) Foreign Application Priority Data
Mar. 20, 2001 (TW) 090106525

(51) Int. Cl. G02F 1/1335

(52) U.S. Cl. 349/113

(57) ABSTRACT

The present invention provides a multi-slants reflector structure and its manufacturing method. Such multi-slants reflector structure is formed simultaneously in the same process of forming TFTs. With a diversity of heights and slanting angles, such reflector structure can have incident light reflect from different angles so as to achieve optimal distribution of reflection intensity versus reflection angle. In application of the multi-slants reflector to an LCD, the function of diversified slanting angles can effectively prevent light concentration on one particular direction. In other words, the present invention is capable of reaching creating an evenly reflective right distribution in a wider range of viewing angles without the aid of a diffuser device.

### BACKGROUND OF THE INVENTION

1. Field of the Invention

The present invention relates to a reflector structure of liquid crystal display (LCD) and its manufacturing method, and more particularly, to a multi-slants reflector structure and manufacturing method thereof.

2. Description of the Prior Art

LCDs were first used in electronic calculators and digital time-telling devices in 1970. Currently, LCDs has are utilized in notebooks, TVs, and word-processors, and popularity of using LCDs in these devices has risen dramatically in the recent past. and the applications thereof are dramatically popular nowadays. Although the most widely used electronic displays are cathode ray tubes (CRTs), CRTs have the shortcomings of a heavy weight, a large size, and high power consumption.

One of the problems of LCDs resides in low reflectivity. Normally, the reflectivity of newspapers is about 55% that of standard whiteboards, and the reflectivity of twisted-nematic (TN) black and white (BW) crystal displays is usually below 25%. Although the contrast ratio of TN BW crystal displays can reach above 5:1, due to its low reflectivity, users still suffer fromthe inconveniences of low reflective brightness and narrow viewing angles . angles.

Please refer to FIG. 1. FIG. 1 is a schematic view showing the reflection of incident light in a mirror reflector structure. Angle α₁, which is an angle between reflecting light 34 and a normal 30, is equal to angle θ, which is an angle between incident light 32 and the normal 30. This condition holds if the normal 30 is vertical to a reflector 38 on a substrate 36.

Please referr to FIG. 2. FIG. 2 is a diagram showing the structure of a conventional LCD having a mirror reflector and a diffuser. A mirror reflector 56 is disposed under a liquid crystal layer 58 in a conventional LCD structure for improving the problem of weak and scattered intensity. With the use of a metal mirror, incident light 50 can be reflected to the direction of reflecting light 52. As described above, it is known that the incident angle of the light will be equal to its reflection angle. Therefore, the reflecting light can have its intensity directed will toward a particular angle through the placement of the mirror reflector 56, as shown in FIG. 2.

Please refer to FIG. 3. FIG.3 is a conventional chart illustrating reflection intensity vs. reflection angle. Curve A represents a function of reflection intensity vs. reflection angle for an LCD having a mirror reflector. As shown by curve A, with a 30-degree incident angle, the reflection angle with greatest reflected intensity is also 30 degrees. This result proves that the reflection angles are actually concentrated toward one particular angle by merely adding a mirror reflector to a conventional LCD. Thus, the LCD cannot be viewed from any other angle due to its low brightness.

Hence, another conventional LCD structure is developed with by implementing a diffuser 64 having the function of smoothening the distribution of reflection intensity under a polarizer 68 and a retardation film 66, as shown in FIG. 3. Please refer back to FIG. 3. Curve B represents a function curve after a diffuser is applied . It is known that the diffuser 64 has the function of diffusing light, thereby improving the problem of the reflection intensity being merely concentrated at 30 degrees, and slightly smoothing the curve of the function of reflection intensity vs. reflection angle.

LCDs are also widely used in digital products such as portable computers and personal digital assistants (PDAs). If only the structures of a mirror reflector and a diffuser are used in an LCD, users always have to fix their viewing angle within a specific range of reflection angles. Otherwise, they cannot see the displayed contents clearly. As a matter of fact, while operating the portable computers or PDAs, users usually maintain their viewing angles approximately in the direction vertical to a display panel, i.e. their viewing angles will fall between the a direction toward which the light is reflecting and a normal direction of the display panel. To improve this drawback, another conventional LCD is thus developed by utilizing a single-slant reflector for reflecting the light toward a direction closer to the normal direction of the display panel.

Please refer to FIG. 4. FIG. 4 shows the theory of light reflection in a slanted reflector structure. Angle θ is an angle between a direction of incident light 42 and a normal direction 40. Angle Φ is an angle between a surface of a reflector 48 on a substrate 46 and the direction of the normal 40, i.e. Φ is a slope angle of a single-slant reflector. Angle α₂, which is an angle between the a direction of reflecting light 44 and the normal direction 40, is equal to 1θ−2Φ1. With this structure, the direction of reflecting light 44 will be closer to the normal direction 40.

A conventional LCD was developed according to said this theory of light reflection, such as shown in FIG. 5. FIG. 5 shows a conventional LCD structure further comprising a single-slant reflector 76. With the addition of the single-slant reflector 76, the reflecting light 72 is obviously closer to the normal direction than the reflecting light 52 shown in FIG. 2. .

The diffuser reserved in the conventional LCD is used for diffusing reflection intensity of particular angles, thereby lessening the parallax. Please refer to FIG. 9. FIG. 9 shows the curves of the function of reflection intensity vs. reflection angle for the conventional LCD having a mirror reflector and for LCDs having a single-slant reflector with various slope angles. Curve G stands for an LCD merely having a mirror reflector and having no diffuser, and curve H₁, H₂, H₃ and H₄ stand respectively for the LCDs merely having a single-slant reflector with various slope angles and having no diffuser. . While When the incident angle of light is 30 degrees, the light intensity reflected by the mirror reflector of the LCD is almost fully peaked in the direction of 30 degrees, as shown in curve G. On the other hand , the reflected light will be slightly closer to the normal direction if the reflector is slanted by just with a few degrees, as shown in curve H₁. With the increase in the slope angle of reflector, the reflecting light is closer and closer to the normal direction, such as shown in curve H₄. Curves H₁, H₂, H₃ and H₄ respectively stands for the curves of reflection intensity vs. reflection angle, in which the slope angle of corresponding reflectors increases from H₁ to H₄. However, curves H₁, H₂, H₃, and H₄ all share a phenomenon in which reflected light intensity is highly concentrated. Accordingly, without the addition of a diffuser, the intensity of the reflected light will be only concentrated on one particular angle and the parallmax will still exist. In other words, these problems cannot be improved by merely utilizing a single-slant reflector with any slope angle. Hence, for a conventional LCD structure, the diffuser has to be disposed over a reflector structure so as to overcome the aforementioned disadvantage. .

The influence of a single-slant reflector on the light reflection is shown in FIG. 6. FIG. 6 shows comparison of the function of reflection intensity vs. reflection angle between an LCD having a mirror reflector and an LCD having a single-slant reflector. Curve B represents the function of reflection intensity vs. reflection angle for an LCD having a mirror reflector and a diffuser, and curve F represents for an LCD having a single-slant reflector and a diffuser. From comparison of these two curves, it is known clear that an LCD having a single-slant reflector can actually make the reflection angle closer to the normal direction.

Most conventional methods use a photo-mask for manufacturing a single-slant reflector. For example, one of the methods uses a half-tone photo-mask for exposing a coated reflector layer with various light intensities , as shown in FIG. 7.Another method uses the position of a mask shift to control the exposure of different effects. A minimum pitch of exposure and lithography has to be particularly considered while a photo-mask is used for defining a pattern of a slanted reflector, so that the definition of a slanting angle thereof can be accurate. In other words, the process of using a photo-mask might only be only suitable for use in manufacturing a single-slant reflector.

Although a diffuser can moderate the distribution of reflection intensity for a conventional LCD with a single-slant reflector, most of the reflection intensity still concentrates on one particular angle. Therefore, the range of the reflection intensity is still too narrow and the brightness in the other angles is insufficient for some kinds of display devices. According to curve F in FIG. 6, it is known that most of the reflection intensity is still concentrated on the angle of about 20 degrees. Therefore, users still need to focus their viewing angle substantially on to the same direction of reflection intensity to obtain better viewing effects.

The relationship between reflection intensity and reflection angle for a whiteboard is shown by curve C in FIG. 8, i.e. the reflection intensity is always the same at any reflection angle. An ideal reflector should be able to reflect the incident light intensively within a particular range in which the reflecting light has sufficient brightness and is evenly distributed, as shown by curves D and E, whereby the LCD can have better operation angles with sufficient brightness.

### SUMMARY OF THE INVENTION

As just mentioned above, the conventional LCD structure has the disadvantage of that the reflecting light being intensively directed to one particular angle. Thus, a goal of the present invention is to provide an LCD having a multi-slants reflector, whereby the LCD can obtain an ideal distribution of reflection intensity and angles.

One of the major objects of the present invention is to provide a multi-slants reflector structure to make reflected light fall within the range of observers viewing angles. Moreover, such structure of the present invention improves the brightness by removing a diffuser structure, which will be scatters and absorbs the reflected light.

Furthermore, another object of the present invention is to provide a method for manufacturing a multi-slants reflector. The method is compatible with a well-known process for manufacturing a thin film transistor (TFT) on conventional LCD displays. During the process for manufacturing TFT elements, the multi-slants reflector structure can also be formed at the same time without any additional steps and cost.

According the objects mentioned above, the present invention is to provides a method for manufacturing a multi-slants reflector. The method comprises forming a plurality of multi-layered structures by accumulating a plurality of deposition layers such as gate, a-Si layer, metal layer, and insulation layer required for manufacturing a TFT of an LCD. The method further comprises coating an organic layer on the multi-layered structures, and then coating a reflection layer by, for example, a metal sputtering method after a baking step is performed for smoothening the surface of the organic layer. Hence, a multi-slants reflector of the present invention can be fabricated by the aforementioned method.

According to the aforementioned manufacturing method of the present invention, the present invention further provides a multi-slants reflector structure, and the multi-slants reflector structure comprises a substrate, a metal layer, a plurality of asymmetric slants, each slant comprising a multi-layered structure and being located between the substrate and the metal layer. The multi-layered structure are is formed on the substrate at the same time as when the deposition layers required for fabricating a TFT are formed, and the asymmetric slants have at least two or more different slanting angles. Angles between the upper surface of the metal layer are formed on the asymmetric slants and the upper surface of the substrate, and an organic layer is located between the aforementioned multi-layered structure and the metal layer.

Furthermore, the present invention provides an LCD structure fabricated by using a multi-slants reflector of the present invention, and the LCD structure comprises two substrates, a multi-slants reflector disposed on one of the two substrates, a transparent conductive membrane located on a surface of the other substrate in which the surface faces toward the multi-slants reflector, and a liquid crystal layer located between the multi-slants reflector and the a transparent conductive membrane. The multi-slants reflector comprises a substrate, a metal layer, and a plurality of asymmetric slants, each slant comprising a multi-layered structure and being located between the substrate and the metal layer. The multi-layered structures are formed simultaneously while a TFT is fabricated. The multi-slants reflector also comprises; and an organic layer located between the metal layer and the multi-layered structure. Further, according to the actual needs, either color filter elements can be disposed on one of the two substrates or a retardation film and a polarizer can be added to the other side (opposite to the side facing the multi-slants reflector) of the substrate.

The asymmetric slants in the aforementioned multi-slants reflector or LCD structure can have the slanting angles from 0 degrees to about 10 degrees, and can have two or more various heights or bottom widths respectively. Furthermore, the asymmetric slants each comprises a multi-layered structure by accumulating a plurality of deposition layers such as gate, a-Si layer, metal layer, and insulation layer required for manufacturing a TFT of an LCD, and each deposition layer may have different heights or widths. Furthermore, the aforementioned deposition layer can be a random composition of a gate, a common line, an insulation layer, an a-Si layer, an N⁺ silicon layer, a source, a drain, and a protection layer, in which the elements of the composition are used for forming a TFT.

One of the features of the present invention is to define the asymmetric slants with various slanting angles by a selective layer deposition method wherein in which each deposition layer having has a different width. With this method, the reflecting light will be closer to the normal direction of the display panel and the reflecting light will be well-distributed in the specific range for users better viewing angle.

The other feature of the present invention is to use the coating and lithography processes used for forming a TFT to define a multi-slants reflector simultaneously, i.e. to use the simultaneously-formed deposition layers such as gate line, a-Si layer, metal layer, or insulation laye to be the multi-layered structure of the multi-slants reflector. . Then, the multi-layered structure is coated with an organic layer having the melting applicability, so that a smooth surface can be made after a baking step is performed. . Hence, these asymmetric slants can be have various slope angles, thereby effectively distributing the reflecting light.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings.

FIG. 1 is a schematic view showing the reflection of incident light in a mirror reflector structure.

FIG. 2 is a diagram showing the a structure of a conventional LCD having a mirror reflector and a diffuser.

FIG. 3 is a conventional diagram comparing a function of reflection intensity vs. reflection angle between an LCD having a mirror reflector and an LCD having a mirror reflector and a diffuser, while incident angle is 30 degrees.

FIG. 4 is a schematic view showing reflection of incident light in a slanted reflector structure.

FIG. 5 is a diagram showing the a structure of a conventional LCD having a single-slant reflector.

FIG. 6 is a conventional diagram comparing the of the function of reflection intensity vs. reflection angle between an LCD having a mirror reflector and an LCD having a single-slant reflector, while incident angle is 30 degrees.

FIG. 7 is a diagram showing a process for manufacturing a structure of the structure ofthe slanted reflector.

FIG. 8 is a conventional diagram comparing the function of reflection intensity vs. reflection angle between an LCD having an ideal slanted reflector and a standard whiteboard.

FIG. 9 is a conventional diagram comparing the function of reflection intensity vs. reflection angle between an LCD having a mirror reflector and LCDs having a single-slant reflector with various slanting angles.

FIG.10 to FIG. 15 show flow different stages of manufacturing an LCD having a multi-slants reflector according to the present invention:

FIG. 16 is a diagram showing the function of reflection intensity vs. reflection angle of an LCD having a multi-slants reflector according to an embodiment of the present invention.

FIG. 17 is a diagram showing the function of reflection intensity vs. reflection angle of an LCD having a multi-slants reflector according to the another embodiment of the present invention.

FIG. 18 is a structural diagram of a color LCD having a multi-slants reflector according to the present invention.

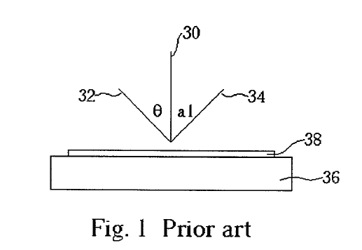

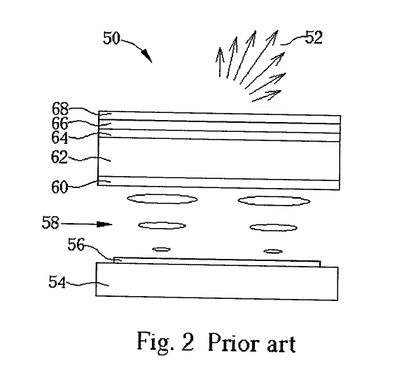

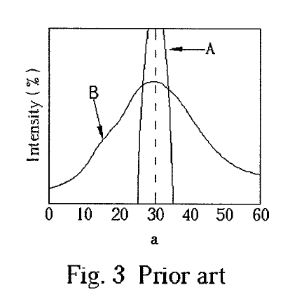

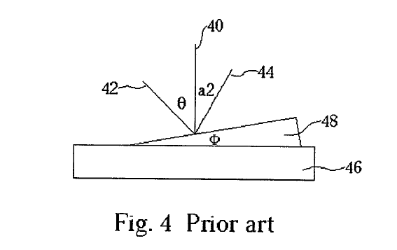

### DETAILED DESCRIPTION

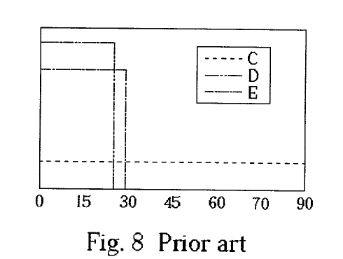

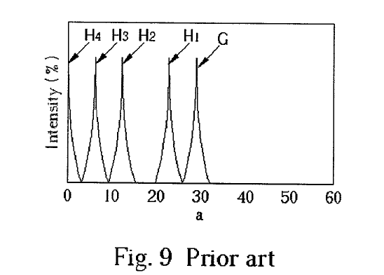

A conventional LCD structure utilizes a single-slant reflector where the light reflection focuses one particular angle and thereby restricts the viewing angle. Hence, the problems of small viewing angle and low brightness occur while a reflective LCD is in operation. According to the statistics, an ideal LCD is that in which the relationship between reflection intensity and reflection angle should be like curve D or E as shown in FIG. 8, i.e. reflection intensity has to be sufficient and evenly distributed within a particular range of angles to enable users to have an optimal viewing angle and reflection intensity while operating a display panel.

The present invention provides a multi-slants reflector structure and the manufacturing method thereof that in which reflecting not only regularizes the viewing angle within a range for users' frequent operation, but also enhances the reflective brightness to be greater than that of a conventional structure without utilizing a diffuser.

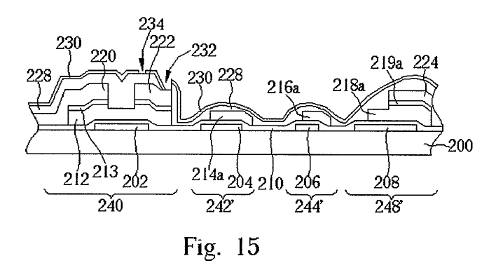

FIG. 15 shows a multi-slants reflector structure of the present invention. The multi-slants reflector structure comprises a substrate 200, a reflective metal layer 230,and a plurality of asymmetric slants 242′, 244′, and 246′, and each asymmetric slant comprises a multi-layered structure 242, 244, and 246(for example, the multi-layered structure 246 of the asymmetric slant 246′ is composed of a gate layer 208, an insulation layer 210, an a-Si layer 218a, an N⁺ silicon layer 219a, and a metal layer 224). The asymmetric slants 242′,244′, and 246′ are disposed between the substrate 200 and the reflective metal layer 230. In particular, the multi-layered structures 242, 244, and 246 of the asymmetric slants 242′, 244′, 246′ are formed on the substrate at the same time when the deposition layers required for fabricating a TFT are formed, and the asymmetric slants 242′, 244′, 246′ have at least two or more different slanting angles. The slanting angles are between the upper surface of the reflective metal layer 230 formed on the asymmetric slants 242′, 244′, 246′ and the upper surface of the substrate 200. An organic layer 228 is located between the aforementioned multi-layered structure 242, 244, 246 and the reflective metal layer 230.

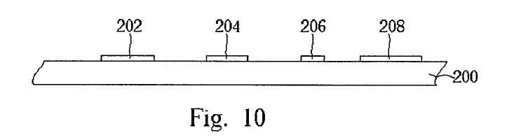

The present invention also utilizes a manufacturing method compatible to with a process for manufacturing a TFT of an LCD, thereby forming a multi-slants reflector structure at the same time as when a TFT is formed. The present invention provides a method for manufacturing a multi-slants reflector structure, such as shown from FIG. 10 to FIG. 15. FIG.10 to FIG. 15 show different stages of manufacturing an LCD having a multi-slants reflector according to an embodiment of the present invention, in which the multi-slants reflector is formed simultaneously with a general process for manufacturing a TFT of an LCD.

Referring to FIG. 10, a gate layer is first deposited on a substrate 200, and then a gate electrode 202 (for manufacturing a TFT) and gates 204, 206 and 208 (for manufacturing asymmetric slants) between two adjacent TFTs are simultaneously defined with a lithographic step. These gates 204, 206 and 208 are used as a layer for the multi-layered structures of the asymmetric slants to form a multi-slants reflector of the present invention. In the embodiment of the present invention, by means of a lithographic step, a width of gate 204 is larger than that of gate 206, and a width of gate 208 is larger than that of gate 204. Hence, a plurality of asymmetric slants with different slant widths is preliminarily defined. The aforementioned description about the widths and the positions is merely used for the as an explanation of an example. The present invention may further select the widths and the positions of gates in accordance with the actual manufacturing process and requirements.

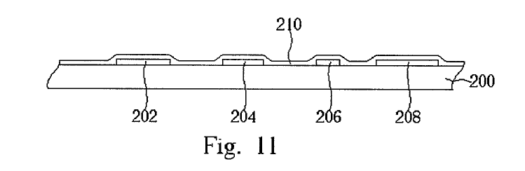

Thereafter, referring to FIG. 11, an insulation layer 210 is coated to cover the structure as shown in FIG. 10. The insulation layer 210 is used as an insulation material over the gate 202 of the TFT, and is also used as a layer for the multi-layered structures of the asymmetric slants to form a multi-slants reflector of the present invention. Since the material of insulation layer 210 is understood by a person skilled in a conventional TFT manufacturing process and is also not a focal point of the present invention, the details will not be described herein.

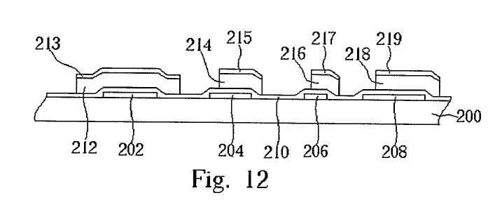

Then, referring FIG. 12, a-Si and N⁺ silicon material, which are required for manufacturing TFT elements, are coated in sequence to cover the structure as shown in FIG. 11. An a-Si layer 212 and an N⁺ silicon layer 213 are defined by means of another lithographic step, and by the same lithographic step, a-Si layers 214, 216 and 218, and N⁺ silicon layers 215, 217 and 219, which belong to the multi-layered structures of the asymmetric slants of the present invention, are simultaneously defined. According to the multi-slants reflector shown by this embodiment of present invention, each a-Si layer and N⁺ silicon layer cover two-thirds of each corresponding gate width, and each layer of multi-layered structures may have different widths or areas. The aforementioned description about the widths and the positions is merely used for the as an explanation of an example. The present invention may further use a lithographic step to select the widths and the positions of a-Si and N⁺ silicon layers in accordance with the actual manufacturing process and requirements.

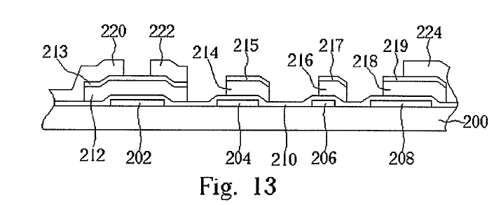

Thereafter, referring FIG. 13, a layer of metal material is coated. Metal layers 220 and 222 of the TFT are defined with a lithographic method, and the metal layers 220 and 222 are used as the source and the drain of the TFT. Meanwhile, a metal layer 224 of a multi-layered structure of an asymmetric slant of the present invention is also defined. According to the multi-slants reflector of this embodiment of the present invention, only N⁺ silicon layer 219 is chosen to be coated on the metal layer 224. In this case, the width of the metal layer 224 is approximately equal to two-thirds of the width of N⁺ silicon layer 219, thereby defining an asymmetric slant with different heights and widths by virtue of different deposition layers. The aforementioned description about the widths and the positions is merely used as an explanation of an example. The present invention may further use a lithographic step to select the widths and the positions of metal layers in accordance with the actual manufacturing process and requirements.

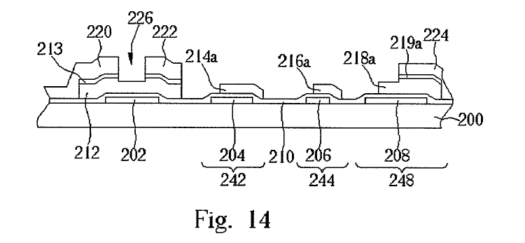

Referring FIG. 14, according to the need for manufacturing a TFT, it is necessary to use metal layers 220 and 222, i.e. the source and the drain, as a photo-mask to etch portions of a-Si and N⁺ silicon layers, thereby forming an etched area 226. During the etching process, portions of the N⁺ silicon layers 215 and 217 not covered by the metal layer 224 and a portion of N⁺ silicon layer 219 are removed simultaneously with only N⁺ silicon layer 219a being left leaving intact. Portions of a-Si layers 214, 216 and 218 are also removed with only a-Si layers 214a, 216a, and 218a being left intact. Thus, the multi-layered structures 242, 244, 246 are completely formed.

Up to the current stage, the asymmetric slants 242′, 244′, and 246′ of a multi-slants reflector of the present invention are basically formed. The feature of the present invention is to utilize coating and lithographic steps that are used for manufacturing a TFT to simultaneously form the multi-layered structures 242, 244, 246 of asymmetric slants 242′, 244′ 246′ of a multi-slant reflector. The aforementioned description about the multi-layered structures242, 244, 246 formed by, such as a gate, an a-Si layer, an N⁺ silicon layer, and a metal layer, which are formed in a process for manufacturing a TFT, and the widths and positions thereof, is merely used as an explanation of an explanation of example. . The present invention may further form the multi-layered structure of the asymmetric slants by selecting and depositing, for example, a gate line, a common line, an insulation layer, an a-Si layer, an N⁺ silicon layer, a source, a drain, a protection layer, and an organic layer. The present invention also may use lithographic steps to define the positions and the widths thereof, thereby defining a plurality of multi-layered structures 242, 244, 246 in different sizes in virtue of a various combination of deposition layers thereon.

Referring to FIG. 15, after TFT 240 and multi-layered structures 242, 244 and 246 are formed, an organic layer 228 having the melting capability is coated thereon, such as shown in FIG. 15. Then, a baking step is performed to smooth the asymmetric slants 242′, 244′, 246′, and a lithographic method is performed to form a contact 232. Thereafter, a reflection metal layer 230 is coated by, for example, sputtering, thereby completing a multi-slants reflector of the present invention. Furthermore, an etching step can be performed on the reflection metal layer 230 to form a short-circuiting opening 234, thereby defining a pixel. Since the steps following the completion of the multi-slants reflector are well understood by a person skilled in the art, they are not described herein.

In the aforementioned steps, a multi-slants reflector can be formed using the organic layer 228 having the melting applicability as a protection layer and coating a metal reflection layer on asymmetric slants after performing the baking and etching steps . On the other hand, a multi-slants reflector can also be formed by coating an organic photo-sensitive layer having the melting applicability on a protection layer, directly performing a baking step to smooth asymmetric slants without removing the organic photo-sensitive layer after the contact window is etched, and then coating a reflection metal layer on the asymmetric slants. Furthermore, in the aforementioned steps, the purpose of coating an organic layer having the melting applicability is to smooth the surfaces of asymmetric slants 242′, 244′ and 246′ of the multi-slants reflectors, thereby having better distribution of light reflection. The aforementioned steps of baking and contact etching can be switched , so that the present invention is not limited to the aforementioned description. .

It is worthy to point out that the present invention is not limited to only three asymmetric slants between two TFTs. One or a plurality of asymmetric slants of different heights and widths between two TFTs can further be manufactured by using deposition layers required for manufacturing a TFT, according to the actual manufacturing process and requirements. Besides, in a multi-slants reflector structure, those three asymmetric slants 242′, 244′ and 246′ are just listed as an explanation of an example, so that the present invention is not limited to that explanation.

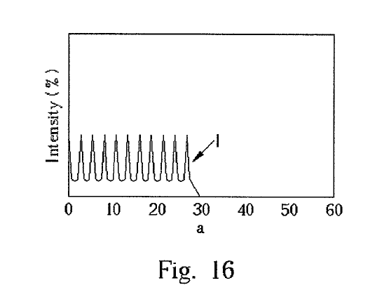

Hence, a multi-slants reflector structure of the present invention can be fabricated by using the aforementioned method. One embodiment of the present invention is to fabricate a multi-slants reflector structure by following the manufacturing flow processes shown in FIG. 10 to FIG. 14, and by directly sputtering the reflection metal layer 230 shown in FIG. 15 thereafter. According to the embodiment, the formed multi-slants reflector formed comprises a substrate 200, a reflection metal layer 230, and asymmetric slants 242′, 244′ and 246′ located between the substrate 200 and the reflection metal layer 230.From the manufacturing method mentioned above, it can be known that the multi-layered structures 242, 244, 246 of asymmetric slants 242′, 244′ and 246′ are formed simultaneously while a TFT 240 is formed, and formed by utilizing deposition layers or any combination thereof with different selected widths and in different selected locations. The deposition layers are the elements required for fabricating the TFT, for example, a gate line, a common line, an insulation layer, an a-Si layer, an N⁺ silicon layer, a source, a drain, and a protection layer . The multi-slants reflector of the present invention can have two or more different slanting angles to reflect the light toward the normal direction so as to achieve an orderly light intensity distribution for an LCD. Please refer to Referring to FIG. 16. FIG. 16 is a diagram depicting an LCD having a multi-slants reflector according to an embodiment of the present invention, in which the intensity is regularly distributed within the range from 0 to 30 degrees to avoid peaking at one particular angle. .

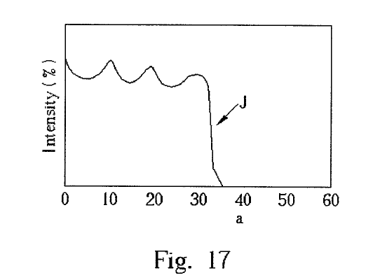

The another preferred embodiment of the present invention is to fabricate a multi-slants reflector structure after the surface thereof is smoothened by following the manufacturing flow processes shown in FIG. 10 to FIG. 15. The preferred embodiment first utilizes a protection layer or the organic layer 228 having the melting applicability to form a smoothing surface over the multi-layered structures 242,244 and 246 after a baking step is performed. The preferred embodiment then forms the reflection metal layer 230 by, for example, sputtering, so as to complete the fabrication of the multi-slants reflector. Hence, the multi-slants reflector structure formed in the present embodiment comprises a substrate 200, a reflection metal layer 230, multi-layered structures 242, 244 and 246 located between the substrate 200 and the reflection metal layer 230, and an organic layer 228 having the melting applicability to cover the multi-layered structures 242, 244,and 246 to form asymmetric slants 242′, 244′ and 246′. Similarly, the asymmetric slants 242′,244′and 246′ can be formed by utilizing deposition layers or any combination thereof with selected widths and selected locations. In this case the deposition layers are the elements required for fabricating a TFT of an LCD such as a gate line, a common line, an insulation layer, an a-Si layer, an N⁺ silicon layer, a source, a drain, and a protection layer. After a smoothening step is performed, the multi-slants reflector structure has a plurality of tangent surfaces of at different slanting angles, and reflecting the reflected light will be more concentrated and evenly distributed within a specific range of users' viewing angles for an LCD to obtain optimum intensity distribution. FIG. 17 is a diagram showing an LCD having a multi-slants reflector according to this embodiment of the present invention. In this diagram, the intensity is not only enhanced but also evenly distributed within the specific range from 0 to 30 degrees, thereby demonstrating the advantage of the present invention over the conventional reflector structures.

From the comparison between reflection intensity curve J shown in FIG. 17, which is obtained from the preferred embodiment in the present invention, and the ideal reflection curve E shown in FIG. 8, it can be shown that the reflection intensity vs. reflection angle curve for an LCD using the multi-slants structure of the present invention is very close to the ideal curve. Therefore, there is no need to add any conventional diffuser in the present invention.

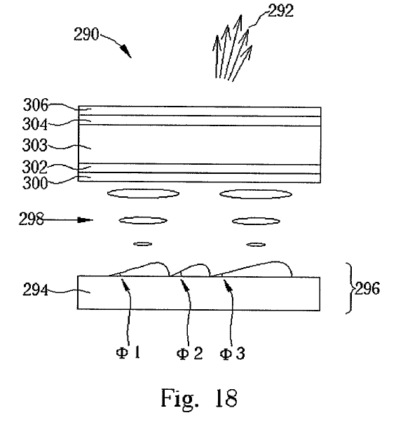

An LCD of better quality can be fabricated by using the multi-slants reflector of the present invention. The structure of LCDs fabricated with the present invention method and having a multi-slants reflector is shown in FIG. 18. The LCD of the present invention comprises a substrate 303 made of light-permissible materialsuch as glass; a multi-slants reflector 296 formed by the method for manufacturing a multi-slants reflector according to the present invention, where the structure of the multi-slants reflector 296 is the same as the one of the present invention; a transparent conductive membrane 300 located on one side of the substrate 303, in which the side of the substrate 303 faces the multi-slants reflector 296; and a crystal liquid layer 298 located between the multi-slants reflector 296 and the transparent conductive membrane 300. The multi-slants reflector 296 has different slanting angles Φ₁, Φ₂, and Φ₃, and these slanting angles are within a range from about 0 degrees to about 10 degrees. It is worthy to point out that the slanting angles of multi-slants reflectors of the present invention are not limited to Φ₁, Φ₂, and Φ₃, but can have various angles and ranges in accordance with the actual requirements. Furthermore, according to the actual product requirements, the LCD structure can be made by implementing a retardation film 304 on the substrate 303, where the retardation film 304 and the transparent conductive membrane 300 are on the different sides of the substrate 303 respectively, and a polarizer 306 can be further added to the retardation film 304. Alternately, the LCD can be made by adding color filter elements 302 between the substrate 303 and the multi-slants reflector 296. .

A feature of the present invention is that the asymmetric slants forming the multi-slants reflector 296 can have various heights and slanting angles Φ₁, Φ₂, and Φ₃, in which the multi-layered structures of asymmetric slants are deposited simultaneously in the same the process for manufacturing a TFT. Therefore, after the incident light 290 passes through the multi-slants reflector 296, the reflecting light 292 is well improved toward the normal direction and the asymmetric slants with various slanting angles can generate a better distribution of reflecting light 292 within a specific range of users viewing angles.

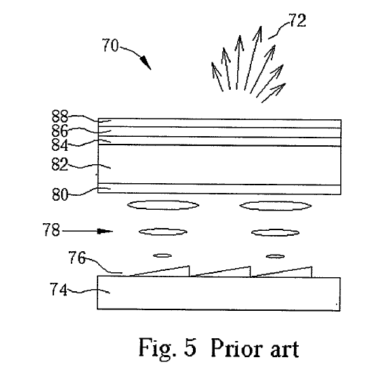

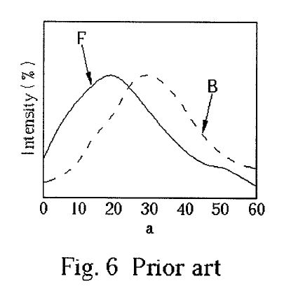

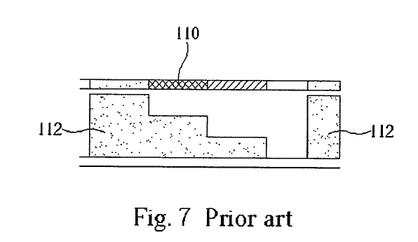

In addition, given that a diffuser has to be disposed in a conventional manufacturing process, the light reflection intensity is thereby reduced to cause lower brightness. One of the features of the present invention is to utilize the smooth surface of a multi-slants reflector to achieve the goal of balancing reflection intensity and reflection angle. In other words, the diffuser is removed in the present invention, so that the reflected light will not be scattered or absorbed. Referring to FIG.18, in comparison comparing with the reflecting light 292 thereof with the reflecting light 72 in FIG. 5, it can be known that the multi-slants reflector structure of the present invention actually makes the reflection intensity more concentrated and only distributes within a specific range of users” viewing angles.

The advantages of the present invention are providing a multi-slants reflector having various slanting angles, widths and heights, thereby reflecting light toward the normal direction from various degrees, so as to diversify the light reflection intensity; utilizing an organic layer having the melting applicability to smooth the surface of the multi-slants reflector; and thus possibly replacing a conventional structure having a single-slant reflector and a diffuser. Furthermore, the present invention also provides a method for manufacturing the multi-slants reflector, where asymmetric slants of the multi-slants reflector can be defined in a general process for manufacturing a TFT of an LCD, and deposited simultaneously while the TFT elements, such as a gate, a common line, an insulation layer, an a-Si layer, an N⁺ layer, a metal layer, a source, and a drain are formed. Hence, the manufacturing method of the present invention not only is compatible to with the conventional TFT manufacturing process, but also achieves the effects of simplifying manufacturing steps and saving production time.

As is understood by a person skilled in the art, the foregoing preferred embodiments of the present invention are illustrative of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A method for manufacturing a multi-slants reflector,comprising the steps of:
providing a substrate;
forming a plurality of thin film transistors and a plurality of multi-layered structures on the substrate simultaneously; and
coating an organic layer on said thin film transistors and said multi-layered structures;
performing a baking step to smooth the organic layer so as to form a plurality of asymmetric slants; and
forming a reflective metal layer on the organic layer.

2. The method of claim 1 for manufacturing a multi-slants reflector, wherein each of said asymmetric slants has substantially different angles between an upper surface of the reflective metal layer and an upper surface of the substrate.

3. The method of claim 1 for manufacturing a multi-slants reflector, wherein each of said asymmetric slants has substantially different heights.

4. The method of claim 1 for manufacturing a multi-slants reflector, wherein each of said asymmetric slants comprises a multi-layered structure, and each layer of said multi-layered structure has substantially different widths.

5. The method of claim 4 for manufacturing a multi-slants reflector, wherein said multi-layered structure is a random composition of a gate metal layer, an insulation layer, an a-Si layer, an N⁺ layer, and a source/drain metal layer.

6. The method of claim 2 for manufacturing a multi-slants reflector, wherein said angles rangeging from 0 degrees to about approximately 10 degrees.

7. A multi-slants reflector applied in a liquid crystal display (LCD), and the multi-slants reflector comprising:
a substrate;
a plurality of thin film transistors disposed on the substrate;
a reflective metal layer;
a plurality of asymmetric slants, each comprising a multi-layered structure, located between the substrate and the reflective metal layer; and
an organic layer located between said reflective metal layer and said multi-layered structure.

8. A multi-slants reflector according to claim 7, wherein each of said asymmetric slants has substantially different angles between an upper surface of the reflective metal layer and an upper surface of the substrate.

9. A multi-slants reflector according to claim 7, wherein each of said asymmetric slants has substantially different heights.

10. A multi-slants reflector according to claim 7, wherein each layer of said multi-layered structure has substantially different widths.

11. A multi-slants reflector according to claim 7, wherein said multi-layered structure is a random composition of a gate metal layer ,an insulation layer, an a-Si layer, an N⁺ layer, and a source/drain metal layer.

12. A multi-slants reflector according to claim 8, wherein said angles range from 0 degrees to about approximately 10 degrees.

13. A method for manufacturing a multi-slants reflector, comprising the steps of:
providing a substrate;
forming a plurality of thin film transistors and a plurality of multi-layered structures on the substrate simultaneously;
coating a protection layer on said thin film transistors and said multi-layered structures; and
forming a reflective metal layer on said protection layer.
